(19) United States
(12) Patent Application Publication
(10) Pub. No.: US 2015/0132185 A1
(43) Pub. Date: May 14, 2015

(54) MULTI VESSEL RING

(71) Applicant: Anania Albert Khamu, Loganholme (AU)

(72) Inventor: Anania Albert Khamu, Loganholme (AU)

(73) Assignee: CHROMOPLAS PTY LTD, Loganholme, QLD (AU)

(21) Appl. No.: 13/810,020

(22) PCT Filed: Jul. 13, 2011
(86) PCT No.: PCT/AU11/00880

§ 371 Date: Dec. 3, 2014

(30) Foreign Application Priority Data
Jul. 14, 2010 (AU) 2010903128

(51) Int. Cl. B01L 3/00; B01L 9/06

(52) U.S. Cl. CPC B01L 3/50851; B01L 3/50853; B01L 9/06; B01L 3/50855; B01L 2300/0803; B01L 2300/043; B01L 2300/042
USPC 422/64; 422/549; 422/550

(57) ABSTRACT

A multi vessel ring (suitable for use with thermal cycler and PCR apparatus) comprises a ring body and a plurality of elongate tubes. Each tube has a proximal open end and a distal closed end, each elongate tube being integrally formed with the ring body, and being pivotally connected to the ring body between an initial position in which a longitudinal axis of each tube is generally parallel with an axis of rotation of the ring body, and a final position in which the longitudinal axis of each tube is inclined relative to the axis of rotation of the ring body. The multi vessel ring preferably further comprises a plurality of caps integrally formed with the ring body, and adapted to seal the proximal open end of respective tubes. A further embodiment is directed to an assembly comprising said ring and a carrier disc having a central hub adapted to be mounted to a thermal cycler, a circumferentially outer portion of the carrier disc having a plurality of grooves, each groove being adapted to support one of said tubes when the multi-vessel ring is located on the carrier disc. A yet further embodiment is directed to a capping tool adapted for use with such an assembly, comprising a loading block having a plurality of projections, each projection being insertable within an aperture formed in an underside of the ring body to push one said cap body from an initial position, in which the cap body is generally coplanar with the ring body, to an intermediate position in which the cap body has rotated more than 90 degrees relative to the ring body.

### FIELD OF THE INVENTION

The present invention relates to a multi vessel ring. In particular, the present invention relates to a multi vessel ring for use in a real-time polymerase chain reaction (PCR) thermal cycling instrument.

### BACKGROUND OF THE INVENTION

A Scientist or skilled technician trained in the relevant field may use a polymerase chain reaction (PCR) to quickly increase the amount of a specific DNA sequence or to detect the existence of a defined sequence within a particular DNA sample of biological material. The PCR can be carried out in a small reaction PCR tube within a thermal cycler. The thermal cycler heats and cools the PCR tubes to achieve the temperatures required at each step of the PCR. In practice, hundreds of PCR tubes may be provided within the thermal cycler at any one time. The PCR may be followed by a high resolution melt (HRM) analysis for the detection of mutations, polymorphisms and epigenetic differences in double stranded DNA samples.

One known device for real time PCR cycling utilises a plastic ring having a plurality of tubes or vessels integrally formed in it. The plastic ring is loaded into a carrier hub, and supported by the thermal cycler. Each of the tubes extends in a direction which is generally parallel to the axis of rotation of the thermal cycler. In operation, the tubes are filled with samples by either manual or robotic means. When all of the tubes have been filled, a plastic film is placed over the openings of the tubes, and the application of heat causes the film to adhere to the plastic ring, thereby sealing each of the tubes.

A disadvantage of the above described plastic ring is that the longitudinal axis of each tube or vessel is generally parallel (or close to parallel) relative to the axis of rotation of the thermal cycler. At times, during the loading of the tubes, it is known for air bubbles to sometimes form in the tube, which can result in inaccurate readings. A further disadvantage with this style of plastic ring is that the use of a single plastic film to seal all of the tubes makes it difficult for a technician to open one or more of the tubes independently without unsealing many of the other tubes. In addition, the use of a single plastic film to seal multiple tubes creates the risk of cross contamination of the contents of the tubes.

Another known device for real time PCR cycling utilises a carrier ring having a space to receive a cartridge typically having tubes or vessels arranged in a row of four. The row of four tubes is integrally formed, and engages the circumference of the ring, such that the tubes are each seated with their longitudinal axis extending at an angle of approximately 45 degrees relative to the axis of rotation of the thermal cycler. A separate cap element is also provided having four integrally formed caps, corresponding to one of the tube cartridges.

During sample testing, a technician loads each of the capped cartridges of tubes into the carrier ring. These are secured by the use of a locking ring to prevent caps from coming loose during the cycling. It has been known that a technician or scientist has forgotten to apply the locking ring—causing the caps to come loose during the cycling. This can cause damage to the thermal cyder, loss of samples and possible contamination of the laboratory.

For example, when the carrier ring has space for 72 tubes, the technician inserts 18 of the cartridges. Once the tubes have been filled manually or by a robotic means, the caps are then manually applied to seal the tubes prior to thermal cycling. A disadvantage of this carrier ring is that it holds each cartridge of 4 tubes in a generally straight line. This means that during rotation in the thermal cycler, some of the cartridges are located at different pitch circle diameters relative to the axis of rotation. This disadvantageously means that each cartridge does not rotate at the same angular velocity, and different spacing exists between end tubes of adjacent cartridges, which may result in inaccuracies in the test results. A further disadvantage of the above described carrier ring is that it is time consuming for a technician or scientist to individually load each of the cartridges into the carrier ring and individually apply their caps.

### OBJECT OF THE INVENTION

It is an object of the present invention to substantially overcome or at least ameliorate one or more of the above disadvantages, or to provide a useful alternative.

### SUMMARY OF THE INVENTION

In a first aspect, the present invention provides a multi vessel ring comprising:
a ring body;
a plurality of elongate tubes, each tube having a proximal open end and a distal dosed end, each elongate tube being integrally formed with the ring body, and being pivotally connected to the ring body between an initial position in which a longitudinal axis of each tube is generally parallel with an axis of rotation of the ring body, and a final position in which the longitudinal axis of each tube is inclined relative to the axis of rotation of the ring body.

The multi vessel ring further preferably comprising a plurality of caps, each cap being integrally formed with the ring body, and adapted to seal the proximal open end of one of the tubes.

Each cap preferably includes:
a cap body;
a resilient arm pivotally connecting the cap body to the ring body; and
an annular flange projecting away from the cap body and adapted to sealingly engage the proximal open end of one of the tubes.

The elongate tubes are preferably arranged circumferentially around the outer perimeter of the ring body.

Each elongate tube is preferably connected to the ring body with a first hinge connected to a portion of an outer wall of the tube, and a second hinge connected to a diametrically opposed portion of the outer wall of the tube.

The first and second hinges are preferably connected to a rib extending radially away from the ring body.

Each elongate tube is preferably adapted to pivot between the initial position in which a longitudinal axis of the tube is generally parallel with a rotation axis of the ring body, and a final position in which one of the caps seals the proximal open end and the longitudinal axis of the tube is generally at 45 degrees relative to the rotation axis of the ring body.

The resilient arm is preferably connected to a radially outer portion of the ring body.

The resilient arm preferably has a restriction having a reduced cross sectional area.

In a second aspect, the present invention provides an assembly comprising:
a multi vessel ring having:
i) a ring body;
ii) a plurality of elongate tubes, each tube having a proximal open end and a distal closed end, each elongate tube being integrally formed with the ring body, and being pivotally connected to the ring body;
a carrier disc having a central hub adapted to be mounted to a thermal cycler, a circumferentially outer portion of the carrier disc having a plurality of grooves, each groove being adapted to support one of said tubes when the multi-vessel ring is located on the carrier disc, and the longitudinal axis of the tube is generally at 45 degrees relative to the rotation axis of the ring body.

The ring body preferably further comprises a plurality of caps, each cap being integrally formed with the ring body, and adapted to seal the proximal open end of one of the tubes, each cap includes:
a cap body;
a resilient arm pivotally connecting the cap body to the ring body; and
an annular flange projecting away from the cap body and adapted to sealingly engage the proximal open end of one of the tubes.

The carrier disc preferably includes a guide surface adapted to guide the elongate tube between a fill position in which a longitudinal axis of the tube is generally parallel with a rotation axis of the ring body, and a closed position in which a longitudinal axis of the tube is generally at 45 degrees relative to the rotation axis of the ring body.

The assembly further preferably comprising a locking ring, the locking ring being engageable with the carrier disc to secure the multi vessel ring between the carrier disc and the locking ring.

The locking ring preferably includes a plurality of abutment surfaces, each abutment surface being adapted to abut against a cap located in the proximal open end of one of said tubes.

A circumferential portion of the locking ring preferably abuts against an outer wall of each tube.

The circumferential portion of the locking ring and the plurality of grooves preferably contact each tube at diametrically opposing regions of a side wall.

In a third aspect, the present invention provides a capping tool for use with the assembly described above, the capping tool comprising:
a loading block having a plurality of projections, each projection being insertable within an aperture formed in an underside of the ring body to push one said cap body from an initial position, in which the cap body is generally coplanar with the ring body, to an intermediate position in which the cap body has rotated more than 90 degrees relative to the ring body.

The capping tool further preferably includes a primary unit, the primary unit having an abutment formation adapted to abut against the ring body to urge the elongate tubes toward the guide surfaces.

The capping tool further preferably includes a secondary unit, the secondary unit including a plurality of guide fingers, each guide finger being adapted to urge one of the caps from the intermediate position to a final position in which the annular flange engages the proximal end of one of the tubes.

Each guide finger preferably has a generally cylindrical profile, and the end portion of the cylinder is chamfered.

### BRIEF DESCRIPTION OF THE DRAWINGS

A preferred embodiment of the invention will now be described by way of specific example with reference to the accompanying drawings, in which:

FIG. 1 is a schematic exploded view of a multi vessel ring and a capping tool;

FIG. 2 is a top view of the multi vessel ring of FIG. 1;

FIG. 3 is a side view of the multi vessel ring of FIG. 1;

FIG. 4 is a partial cross-sectional side view of the multi vessel ring of FIG. 1 in a starting position;

FIG. 5 is a partial cross-sectional side view of the multi vessel ring of FIG. 1 in an intermediate position;

FIG. 6 is a is a partial cross-sectional side view of the multi vessel ring of FIG. 1 in a final position;

FIG. 7 is a full cross-sectional side view of the multi vessel ring of FIG. 1 in the starting position;

FIG. 8 is a full cross-sectional side view of the multi vessel ring of FIG. 1 in the intermediate position;

FIG. 9 is a full cross-sectional side view of the multi vessel ring of FIG. 1 in the final position;

FIG. 10a is a partial top view of the multi vessel ring of FIG. 1;

FIG. 10b is a partial top view of the multi vessel ring of FIG. 10a, in an intermediate position;

FIG. 11 is a schematic exploded view of an assembly including the multi vessel ring of FIG. 1;

FIG. 12 is a side cross-sectional view of the assembly of FIG. 11;

FIG. 13 is a top view of a carrier ring of the assembly of FIG. 11;

FIG. 14 is a side view of the carrier ring of the assembly of FIG. 11;

FIG. 15 is a cross-sectional view of the carrier ring of FIG. 14;

FIG. 16 is a cross-sectional detail showing a portion of the carrier ring of FIG. 15;

FIG. 17 is a top view of a locking ring of the assembly of FIG. 11;

FIG. 18 is a sectional view of the locking ring of FIG. 17;

FIG. 19 is a partial cross-sectional side view of the locking ring of FIG. 17;

FIG. 20 is a cross-sectional view of the multi vessel ring of FIG. 1 and the carrier ring of FIG. 13 mounted on a loading block, with the multi vessel ring shown in the starting position;

FIG. 21 is a cross-sectional view of the multi vessel ring of FIG. 1 and the carrier ring of FIG. 13 mounted on a loading block, with the multi vessel ring shown in the intermediate position;

FIG. 22 is a cross-sectional view of the multi vessel ring of FIG. 1 and the carrier ring of

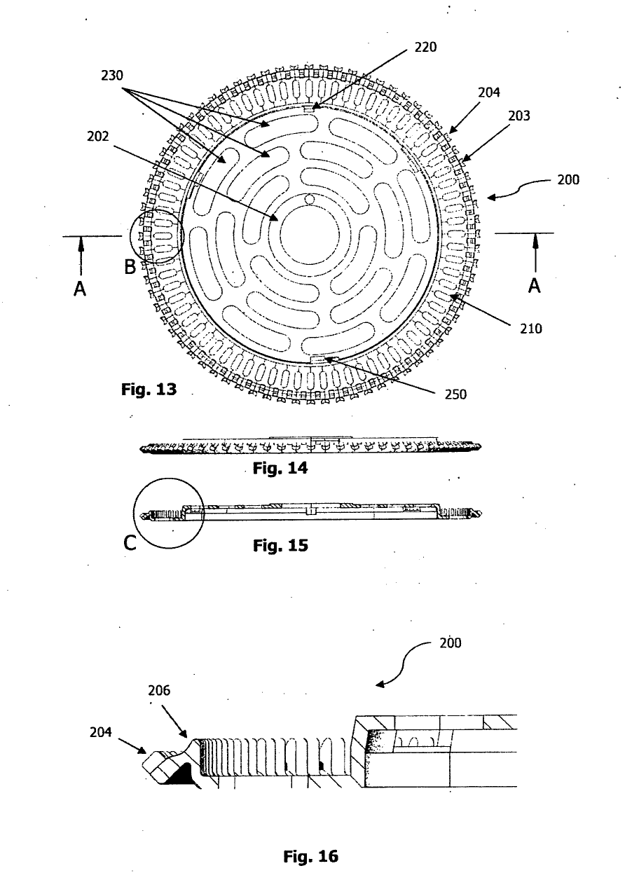

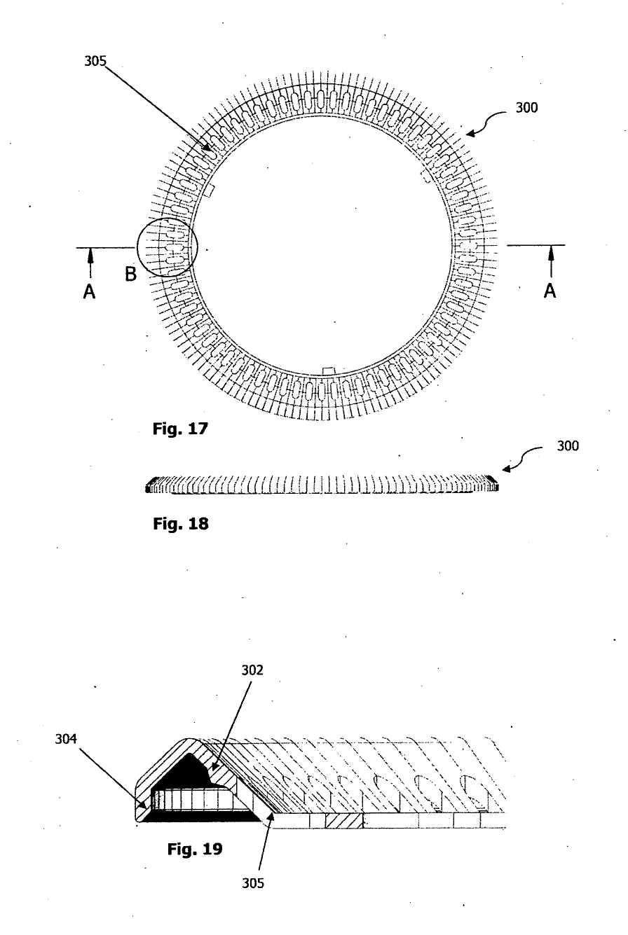

FIG. 13 mounted on a loading block, with the multi vessel ring shown in the final position.

FIG. 23 is a cross-sectional view of a capping tool and multi vessel ring in a first position;

FIG. 24 is a cross-sectional view of the capping tool and multi vessel ring in an intermediate position;

FIG. 25 is a further cross-sectional view of the capping tool and multi vessel ring in an intermediate position; and

FIG. 26 is a cross-sectional view of the capping tool, and multi vessel ring in a final position.

### DETAILED DESCRIPTION OF THE PREFERRED EMBODIMENTS

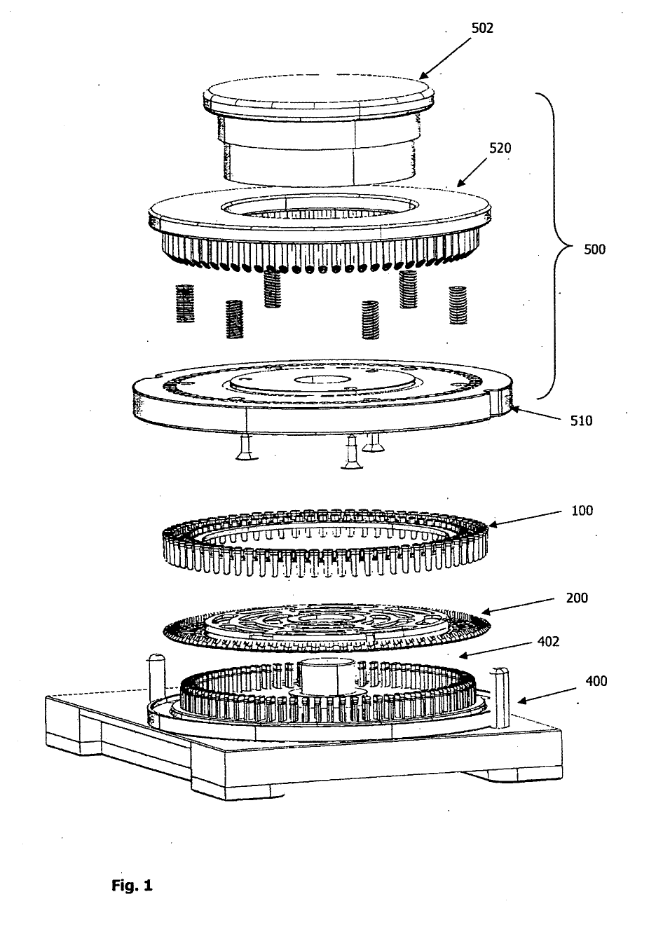

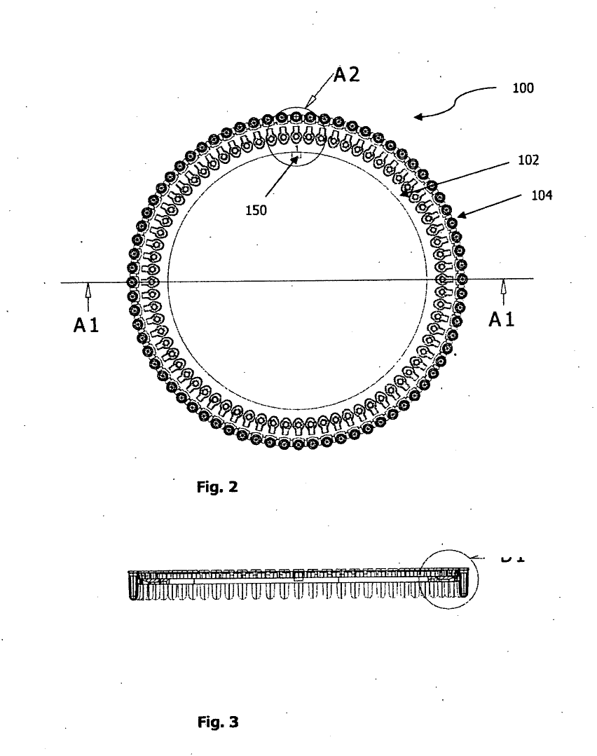

FIG. 1 depicts a schematic exploded view of a multi vessel ring 100 and a capping tool 500. The multi vessel ring 100 is shown in more detail in FIGS. 2 to 10. The multi vessel ring 100 is used to store a biological or other sample during thermal cycling. As shown in FIG. 2, the multi vessel ring 100 includes a ring body 102 which has a generally annular shape, and is made from plastic.

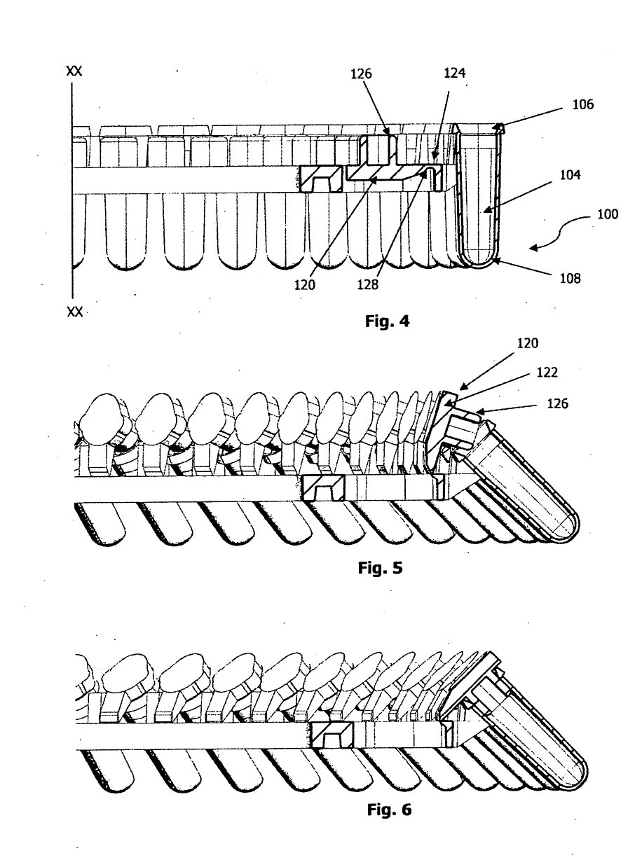

The multi vessel ring 100 includes a plurality of elongate sample storage vessels or tubes 104. The tubes 104 are best shown in FIGS. 4 to 6. As shown in FIG. 4, each tube 104 has a proximal open end 106 and a distal closed end 108. Each elongate tube 104 is integrally formed with the ring body 102 in a single piece manufacturing process, and each tube 104 is pivotally connected to the ring body 102. In the embodiment depicted in the drawings, the multi vessel ring 100 has 72 tubes 104 arranged circumferentially around the outer perimeter of the ring body 102. However, it will be appreciated by those skilled in the art, that the multi vessel ring 100 may be manufactured with a larger or smaller number of tubes 104, and the size of the tubes may range from small tubes used for example during DNA testing, to larger tubes used for example during blood testing.

As shown FIGS. 4 to 6, the multi vessel ring 100 includes a plurality of caps 120. Each cap 120 is integrally formed with the ring body 102, and each cap 120 is adapted to seal the proximal open end 106 of one of the tubes 104. Each cap 120 includes a cap body 122 and a resilient hinge or arm 124 pivotally connecting the cap body 122 to the ring body 102. The cap 120 further includes an annular flange 126 which projects away from the cap body 122 and is adapted to sealingly engage the proximal open end 106 of one of the tubes 104. The annular flange 126 has a diameter which is adapted to interferingly engage with the inside wall of the tube 104.

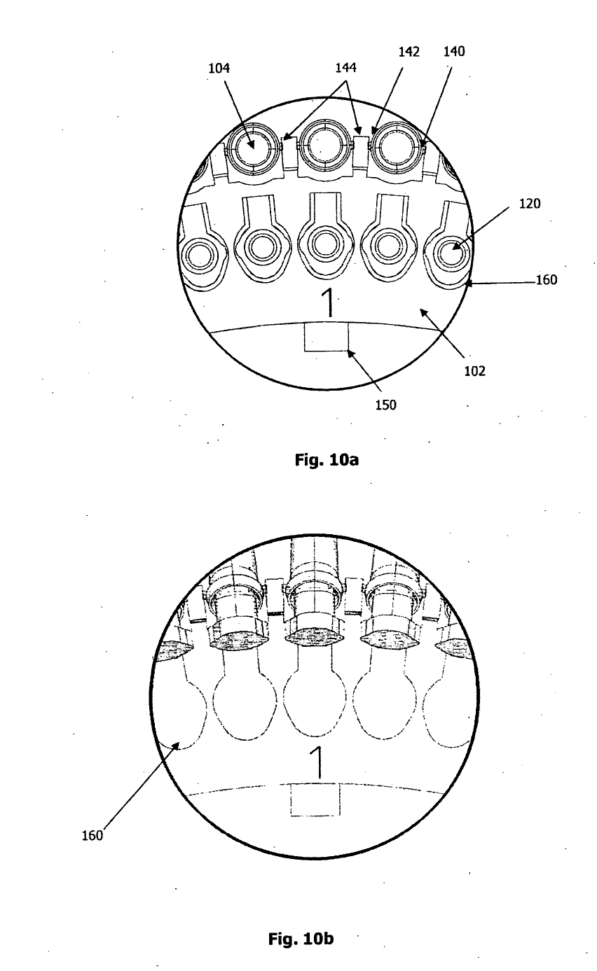

In the configuration, shown in FIG. 4, the cap 120 is in the initial starting position, after manufacture. In this position, a longitudinal axis of each of the tubes 104 extends generally parallel to the rotational axis XX of the ring body 102. In addition, the cap body 122 is generally coplanar with the ring body 102. As can be seen from the top view in FIG. 2, and the detail of FIG. 10, each cap body 122 is stamped out of the ring body, such that the only portion of the cap 120 which is attached to the ring body 102 is the arm 124. As shown. in FIG. 4, there is a restriction 128 formed in each arm 124. The restriction 128 acts as a pivot point about which the cap 120 pivots. The arm 124 is connected to a radially outer portion of the ring body 102.

FIG. 5 shows the ring body 102 with the caps 120 in an intermediate, partially closed position. In this position, the cap 120 has pivoted about the restriction 128 by an angle of more than 90 degrees. Also shown in FIG. 5, the tubes 104 have each pivoted relative to the ring body 102, such that a longitudinal axis of each elongate tube 104 intersects the axis of rotation XX of the ring body 102 at an angle of about 45 degrees. In this position, the annular flange 126 is starting to enter the proximal open end 106. As shown in FIG. 5, the proximal open end 106 of each tube 104 is chamfered or flared to assist in guiding the annular flange 126 into the open end 106.

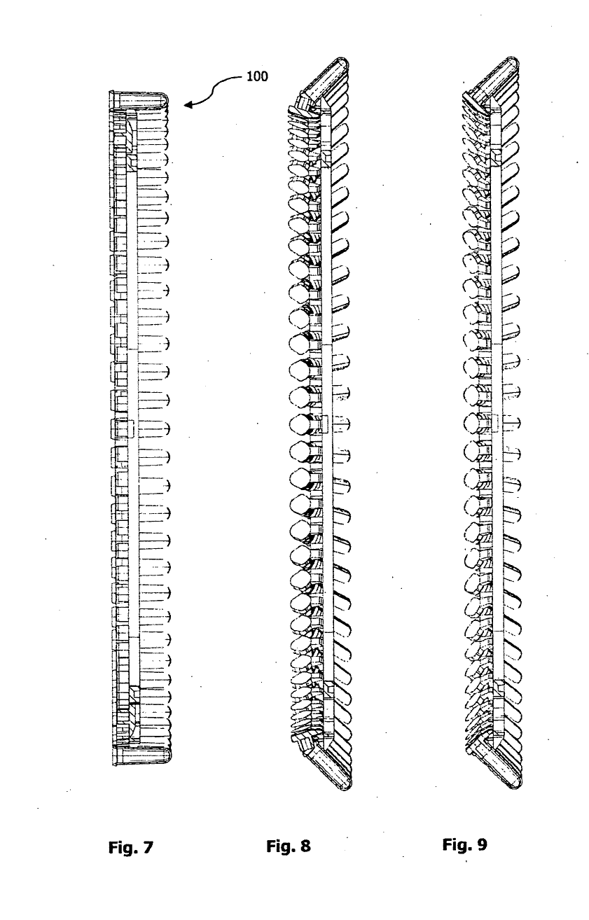

FIG. 6 depicts the final position, in which the annular flange 126 of the cap 120 is fully located within the tube 104. In this position, the contents of the tube 104 are sealed inside. FIGS. 7 to 9 depict the starting, intermediate and final positions of the ring body 102 respectively.

Referring to FIG. 10a, each elongate tube 104 is connected to the ring body 102 with a first hinge 140 connected to a portion of an outer wall of the tube 104, and a second hinge 142 connected to a diametrically opposed portion of the outer wall of the tube 104. As such, the tube 104 is supported from both sides. The hinges 140, 142 are formed from small necks of plastic, that are elastically deformable, enabling the tubes 104 to pivot.

Again referring to FIG. 10a, the first and second hinges 140, 142 are each connected to a projection or rib 144 which extends radially away from the ring body 102. The width of each cap body 122 is larger than the space formed between two adjacent ribs 144. Accordingly, the cap body 122 is unable to pass through the space between two adjacent ribs 144. As a result of the cap body 122 being restricted by the space between adjacent ribs 144, the tube 104 is pivotally isolated and held at an angle of around 45 degrees relative to the axis of rotation XX, which is an optimal angle for the thermal cycling process.

As described above, each elongate tube 104 is adapted to pivot between a fill position in which a longitudinal axis of the tube 104 is generally parallel with a rotation axis XX of the ring body 102, and a closed position in which one of the caps 120 seals the proximal open end 106, and the longitudinal axis of the tube 104 is generally at 45 degrees relative to the rotation axis of the ring body 102.

As shown in FIGS. 2 and 10a, the multi vessel ring 100 has a tab 150 which extends inwardly into the centre of the ring 102, and each tube 104 on the ring body 102 may be numbered or labelled to identify the tube 104 individually, for example, between 1 and 72.

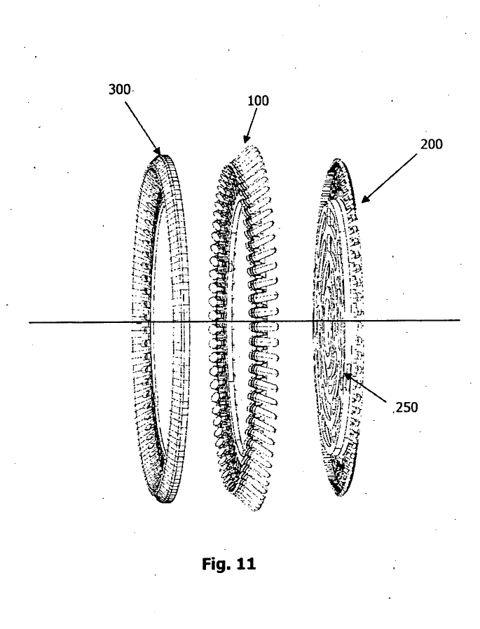

A carrier disc 200 is shown in the assembly of FIG. 1. The carrier disc 200 is depicted in more detail in FIGS. 11 to 16. The carrier disc 200 is manufactured from aluminium, stainless steel, or another suitable engineering material. The carrier disc 200 is used to support the multi vessel ring 100.

The carrier disc 200 may be manufactured with a central hub 202 which can be mounted and secured to a thermal cyder.

Referring to FIG. 13, the carrier disc 200 has a generally rectangular slot 220 which corresponds to the tab 150 on the multi vessel ring 100. This ensures that the multi vessel ring 100 is always correctly angularly oriented on the carrier disc 200, so that if the tubes 104 are mechanically filled by a robot, the correct tube number is located in the position corresponding to that tube 104 during filling. Accordingly, if the multi vessel ring 100 is removed from the carrier disc 200, and then returned to the carrier disc 200, it will always be in the same angular position.

Referring to FIG. 13, a circumferentially outer portion 203 of the carrier disc 200 has a plurality of grooves 204. Each groove 204 is adapted to support one of the tubes 104 when the multi-vessel ring 100 is located adjacent to and in abutment with the carrier disc 200, in the final position. As shown in the side view of FIG. 14, the grooves 204 have the form of a plurality of scallops or corrugations formatted evenly around the circumference of the carrier disc 200.

to Referring to the cross-sectional detail of FIG. 16, the carrier disc 200 indudes a plurality of sloping guide surfaces 206. Each guide surface 206 guides one of the elongate tubes 104 between the starting position when the longitudinal axis of the tube 104 is generally parallel with a rotation axis XX of the ring body 102, and the final, closed position in which the longitudinal axis of the tube 104 is generally at 45 degrees relative to the rotation axis XX of the ring body 102. The guide surface 206 acts to guide the tubes 104 to pivot radially outwardly.

As shown in FIG. 13, the carrier disc 200 includes a plurality of radially extending slots 210, which are evenly spaced on an equal pitch circle diameter around the carrier disc 200. The slots 210 correspond in location to the caps 120 when the multi vessel ring 100 is placed over the carrier disc 200.

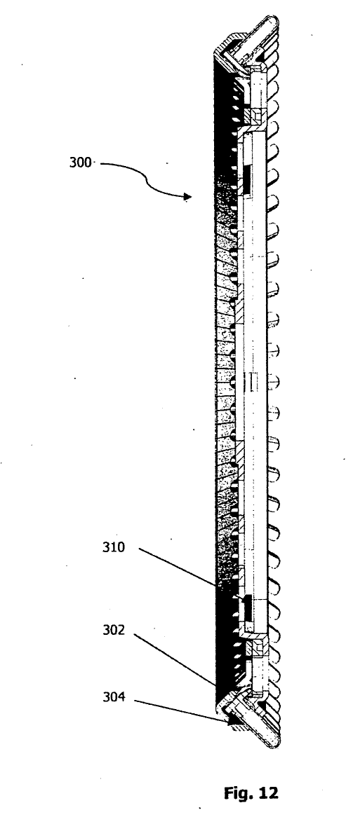

The radially extending slots 210 also act as additional ventilation. When the locking ring 300 is fitted, the radially extending slots 210 in the carrier disc 200 align with radially extending slots 305 on the locking ring 300 and the void 160 remaining from the original position of the cap 120, to allow ventilation behind the tube 104 and sealed cap 120 as shown in FIG. 12. This is to assist in rapid temperature change. FIG. 10b shows the voids 160 when the caps 120 have been moved to the intermediate position.

ao As shown in FIG. 13, ventilation is also improved by the elongate slots 230 on the surface of the middle section of the carrier disc 200. These are designed to maximise airflow, enabling faster heating and cooling cycles.

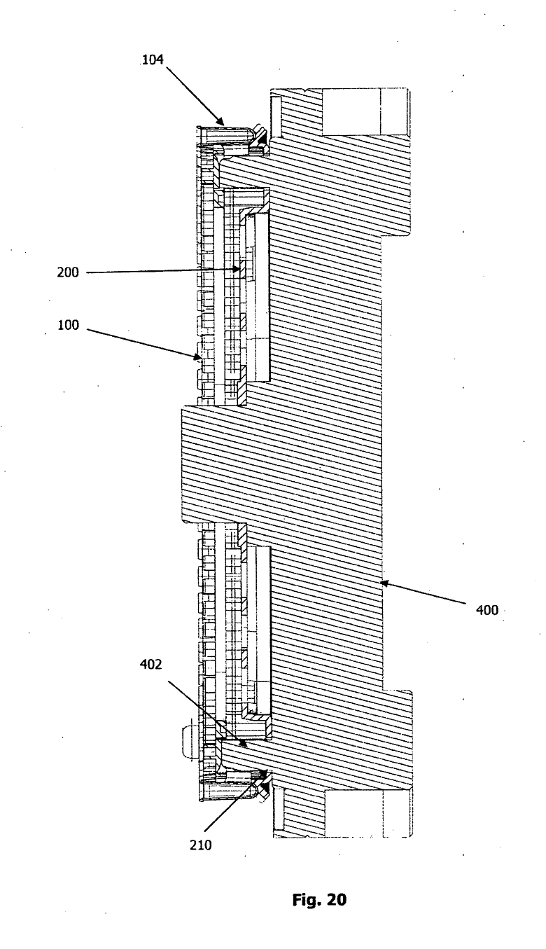

A loading block 400 and capping tool 500 is shown in FIG. 1 for use with the multi vessel ring 100. The loading block 400 is shown in cross-section in FIG. 20 and has a plurality of fingers or projections 402 located on a pitch circle diameter. The cross-sectional view of FIG. 20 shows the multi vessel ring 100 and carrier disc 200 being loaded onto the loading block 400. As shown, each of the fingers 402 passes through one of the radially extending slots 210 in the carrier disc 200.

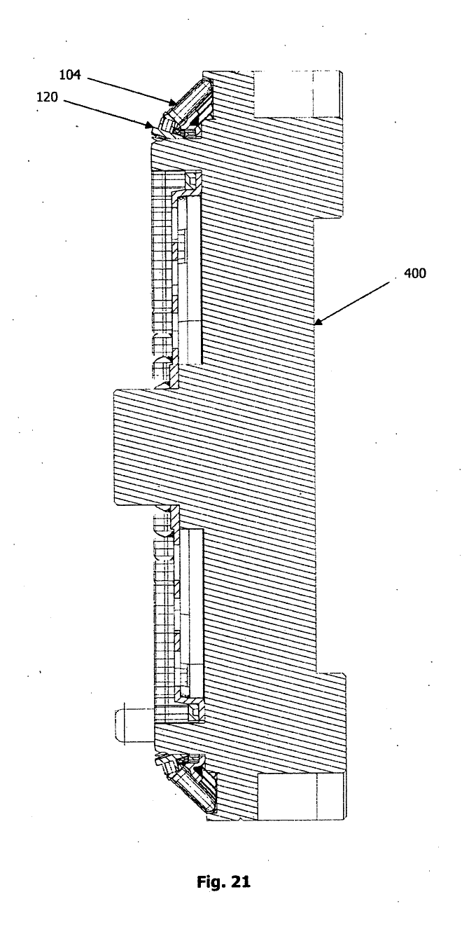

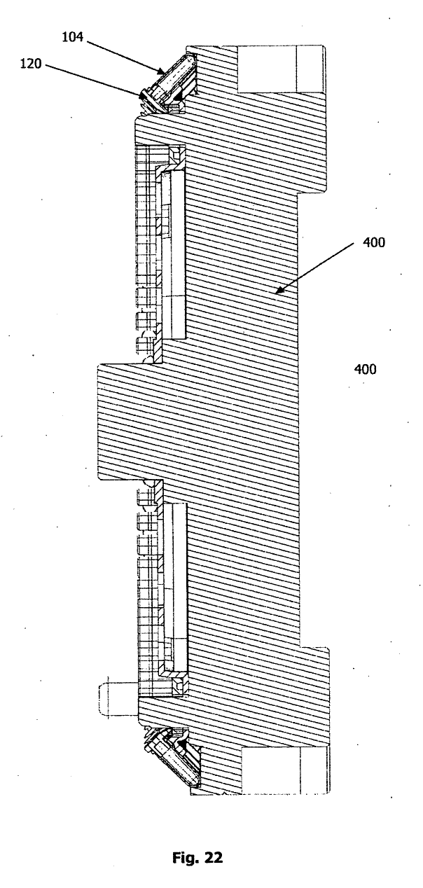

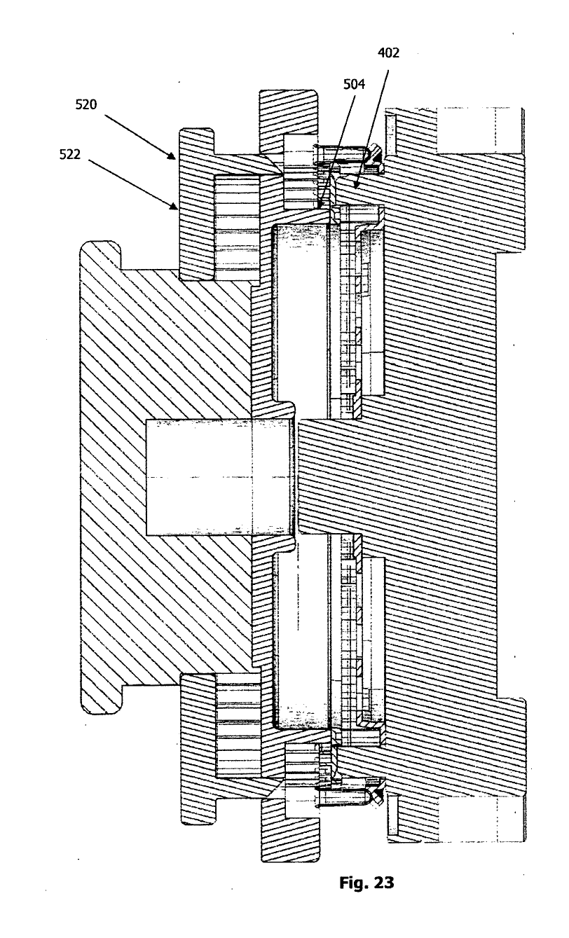

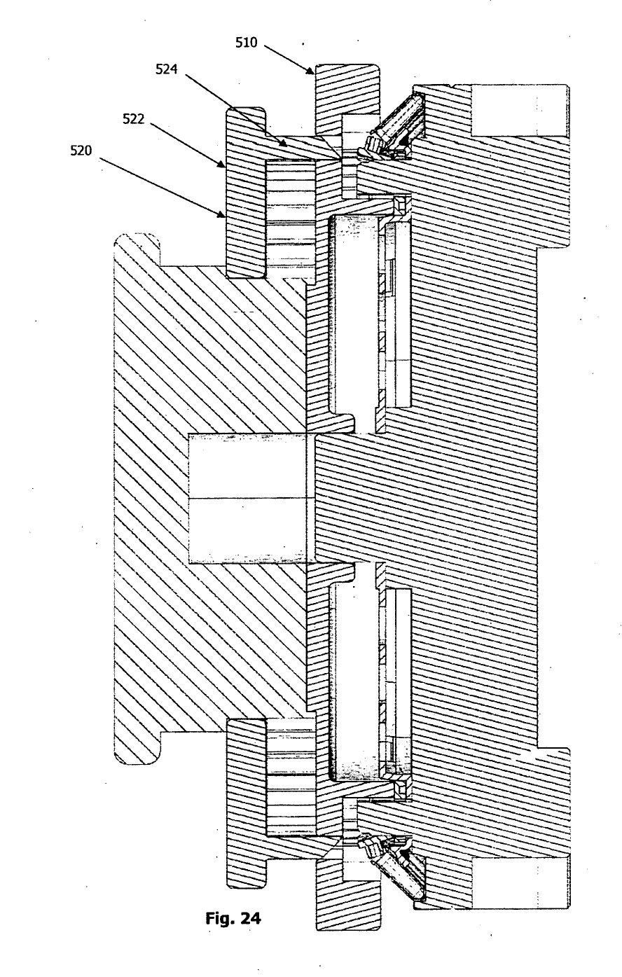

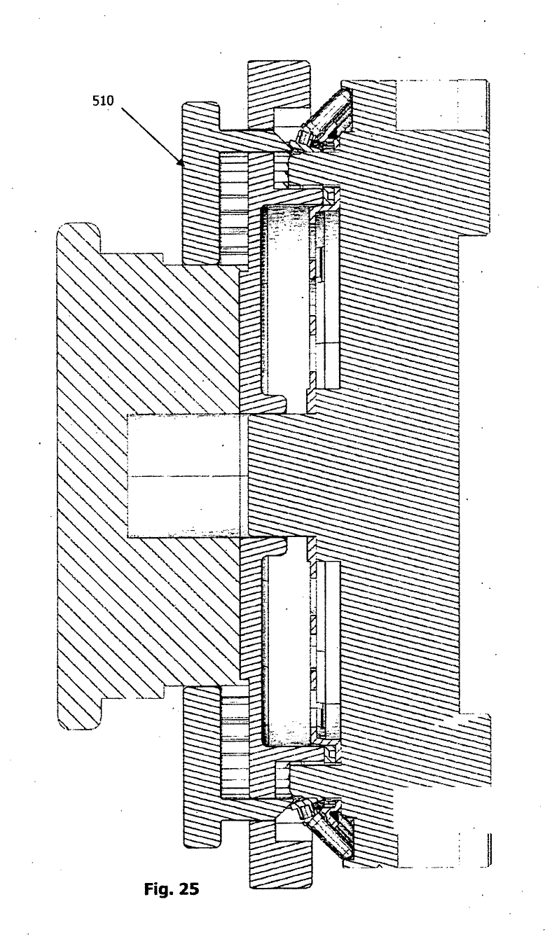

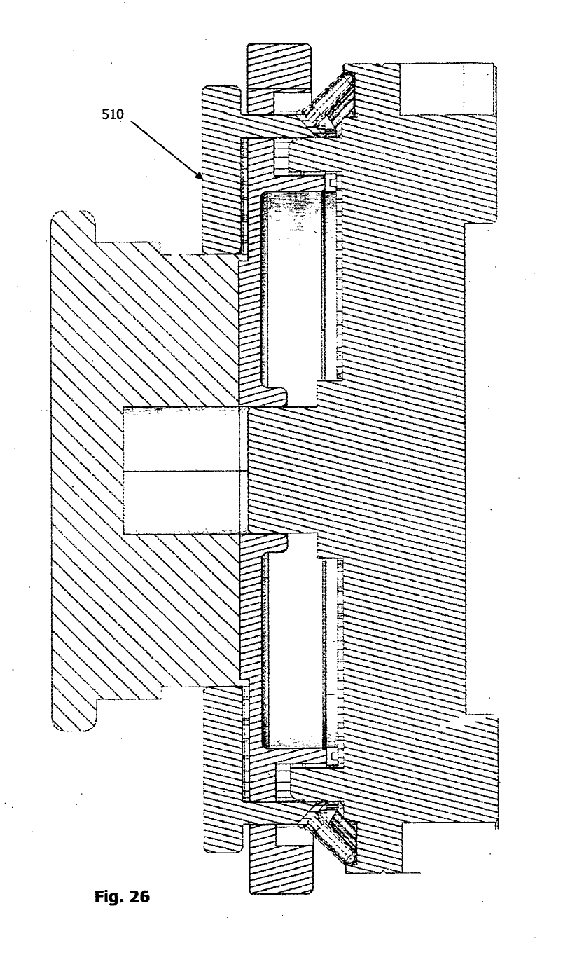

The finger 402 then comes into abutment with the underside of one of the caps 120, in the position depicted in FIG. 20. This represents the fill stage of the process, and a robot or technician can insert a biological sample into each of the tubes 104. The intermediate position is shown in FIG. 21 and the final position in FIG. 22.

As shown in FIG. 23, when the tubes 104 have been filled, the capping tool 500 which has a primary unit 510 and a secondary unit 520 is placed over the loading block 400 above the multi vessel ring 100. When a technician pushes down on the central hub 502 of the primary unit 510 of the capping tool 500, an abutment formation in the form of an annular flange 504 engages the ring body 102. The force causes each of the tubes 104 to be initially seated against one Of the guide surface 206. With further force, the guide surfaces 206 guide all of the tubes radially 104 outwardly, to the intermediate position as depicted in FIG. 24. In the intermediate position, each of the tubes 104 is seated on one of the grooves 204, and the longitudinal axis of each tube 104 extends at around 45 degrees relative to the axis of rotation XX.

During advancement to the intermediate position, the fingers 402 push each of the caps 120 upwardly and away from the plane of the ring body 102. The intermediate position is depicted in FIG. 24. As shown in that figure, each cap body 122 has pivoted slightly more than 90 degrees from its original position.

As shown in FIG. 24, the secondary unit 520 of the capping tool 500 has a spring loaded annular plate 522. The plate 522 has a plurality of cylindrical guide fingers or rods 524. The tip of each rod 524 is chamfered at an angle of approximately 45 degrees, and adapted to urge one of the caps 120 from the intermediate position shown in FIG. 24 to the final position shown in FIG. 26 in which the tubes 104 are sealed.

When the tubes 104 have all been sealed, as depicted in FIG. 26, the capping tool 500 is removed. At this stage the multi vessel ring 100 is removed from the loading block 400. A locking ring 300 as shown in FIGS. 11 and 12 is then placed on top of the multi vessel ring 100. The locking ring 300 is engageable with the carrier disc 200, to sandwich the multi vessel ring 100 between the carrier disc 200 and the locking ring 300.

The locking ring 300 includes abutment surfaces 302 adapted to abut against each cap 120 preventing the tube 104 from opening during thermal cycling. A circumferential portion 304 of the locking ring 300 abuts against an outer wall of each tube 104. The circumferential portion 304 of the locking ring 300 and the plurality of grooves 204 of the carrier disc 200 each contact the tubes 104 on diametrically opposing regions of the side wall of the tube 104.

The locking ring 300 has a locking formation 310 which locks into a slot or aperture 250 formed in the carrier disc 200 by way of a threaded motion, such that rotating the locking ring 300 relative to the carrier disc 200 results in engagement. The locking formation 310 engages in such a manner that it will not open during rotation of the assembly in a thermal cycler.

Although the invention has been described with reference to specific examples, it will be appreciated by those skilled in the art that the invention may be embodied in many other forms.

1. A multi vessel ring comprising:
a ring body;
a plurality of elongate tubes, each tube having a proximal open end and a distal closed end, each elongate tube being integrally formed with the ring body, and being pivotally connected to the ring body between an initial position in which a longitudinal axis of each tube is generally parallel with an axis of rotation of the ring body, and a final position in which the longitudinal axis of each tube is inclined relative to the axis of rotation of the ring body.

2. The multi vessel ring of claim 1, further comprising a plurality of caps, each cap being integrally formed with the ring body, and adapted to seal the proximal open end of one of the tubes.

3. The multi vessel ring of claim 2, wherein each cap includes:
a cap body;
a resilient arm pivotally connecting the cap body to the ring body; and
an annular flange projecting away from the cap body and adapted to sealingly engage the proximal open end of one of the tubes.

4. The multi vessel ring of claim 2, wherein the elongate tubes are arranged circumferentially around the outer perimeter of the ring body.

5. The multi vessel ring of claim 4, wherein each elongate tube is connected to the ring body with a first hinge connected to a portion of an outer wall of the tube, and a second hinge connected to a diametrically opposed portion of the outer wall of the tube.

6. The multi-vessel ring of claim 5, wherein the first and second hinges are each connected to ribs extending radially away from the ring body.

7. The multi vessel ring of claim 1, wherein each elongate tube is adapted to pivot between the initial position in which a longitudinal axis of the tube is generally parallel with a rotation axis of the ring body, and a final position in which one of the caps seals the proximal open end and the longitudinal axis of the tube is generally inclined at 45 degrees relative to the rotation axis of the ring body.

8. The multi vessel retaining ring of claim 7, wherein a resilient arm extends between a radially outer portion of the ring body and each cap.

9. The multi vessel retaining ring of claim 8, wherein the resilient arm has a restriction having a reduced cross sectional area.

10. An assembly comprising:
a multi vessel ring having:
i) a ring body;
ii) a plurality of elongate tubes, each tube having a proximal open end and a distal closed end, each elongate tube being integrally formed with the ring body, and being pivotally connected to the ring body;
a carrier disc having a central hub adapted to be mounted to a thermal cycler, a circumferentially outer portion of the carrier disc having a plurality of grooves, each groove being adapted to support one of said tubes when the multi-vessel ring is located on the carrier disc, and the longitudinal axis of the tube is generally at 45 degrees relative to the rotation axis of the ring body.

11. The assembly of claim 10, wherein the ring body further comprises a plurality of caps, each cap being integrally formed with the ring body, and adapted to seal the proximal open end of one of the tubes, each cap includes:
a cap body;
a resilient arm pivotally connecting the cap body to the ring body; and
an annular flange projecting away from the cap body and adapted to sealingly engage the proximal open end of one of the tubes.

12. The assembly of claim 10, wherein the carrier disc includes a guide surface adapted to guide the elongate tube between a fill position in which a longitudinal axis of the tube is generally parallel with a rotation axis of the ring body, and a closed position in which a longitudinal axis of the tube is generally at 45 degrees relative to the rotation axis of the ring body.

13. The assembly of claim 10 further comprising a locking ring, the locking ring being engageable with the carrier disc to secure the multi vessel ring between the carrier disc and the locking ring.

14. The assembly of claim 13, wherein the locking ring includes a plurality of abutment surfaces each abutment surface being adapted to abut against a cap located in the proximal open end of one of said tubes.

15. The assembly of claim 13, wherein a circumferential portion of the locking ring abuts against an outer wall of each tube.

16. The assembly of claim 15, wherein the circumferential portion of the locking ring and the plurality of grooves contact each tube at diametrically opposing regions of a side wall.

17. A capping tool for use with the assembly of claim 12, the capping tool comprising:
a loading block having a plurality of projections, each projection being insertable within an aperture formed in an underside of the ring body to push one said cap body from an initial position, in which the cap body is generally coplanar with the ring body, to an intermediate position in which the cap body has rotated more than 90 degrees relative to the ring body.

18. The capping tool of claim 17, further including a primary unit, the primary unit having an abutment formation adapted to abut against the ring body to urge the elongate tubes toward the guide surfaces.

19. The capping tool of claim 18, further including a secondary unit, the secondary unit including a plurality of guide fingers, each guide finger being adapted to urge one of the caps from the intermediate position to a final position in which the annular flange engages the proximal end of one of the tubes.

20. The capping tool of claim 19, wherein each guide finger has a generally cylindrical profile, and the end portion of the cylinder is chamfered.
